(19) United States
(12) Patent Application Publication
(10) Pub. No.: US 2008/0017816 A1
(43) Pub. Date: Jan. 24, 2008

(54) Thermal isolator for actuator and valve assembly

(75) Inventors: Robin Willats, Columbus, IN (US); Joseph Callahan, Greenwood, IN (US); Terry Holley, Trafalgar, IN (US); Yin Chen, Indianapolis, IN (US)

Correspondence Address: CARLSON, GASKEY & OLDS, P.C., 400 WEST MAPLE ROAD, SUITE 350, BIRMINGHAM, MI, 48009, US

(73) Assignee: Arvin Technologies, Inc.

(21) Appl. No.: 11/491,836

(22) Filed: Jul. 24, 2006

(51) Int. Cl. F16K 31/44

(52) U.S. Cl. 251/77

(57) ABSTRACT

An exhaust valve assembly includes a valve body, a valve supported by a shaft within the valve body, and an actuator that drives the shaft to move the valve relative to the valve body. A thermal isolator is associated with the shaft to reduce heat transfer from the valve to the actuator.

### TECHNICAL FIELD

The subject invention relates to a thermal isolator between an actuator and an exhaust valve that reduces heat transfer from the exhaust valve to the actuator.

### BACKGROUND OF THE INVENTION

Exhaust valve assemblies include a flapper valve that is supported on a shaft within an exhaust tube. An actuator drives the shaft to move the flapper valve within the exhaust tube to control exhaust flow. Actuators can include spring actuators, electric actuators such as motors or solenoids, or vacuum actuators, for example.

Each type of actuator has an operating temperature limitation. Exhaust gases that flow through the exhaust tube can reach very high temperature levels. Disadvantageously, these high temperatures can be transferred to the actuator via the shaft, which can adversely affect operation of the actuator.

One proposed solution has been to extend a length of the shaft to reduce the temperature at the actuator. However, increasing shaft length increases overall packaging of the exhaust valve assembly, which is not desirable.

Thus, there is a need for an improved exhaust valve assembly that reduces heat transfer from a valve to an actuator, while additionally providing a more flexible and compact design configuration.

### SUMMARY OF THE INVENTION

An exhaust valve assembly includes a thermal isolator that is used to reduce heat transfer from a valve to an actuator. The valve is supported by a shaft within a valve body. The actuator drives the shaft to move the valve relative to the valve body.

In one example, the shaft comprises a valve shaft that is attached to the valve. The actuator has an actuator shaft that forms an output from the actuator. The thermal isolator comprises a coupling that couples the actuator shaft to the valve shaft to transfer torque between the actuator and the valve.

In one example, the coupling comprises a flexible metal bellows.

In another example, the coupling comprises a connector made of an insulating material such as ceramic or silicon, for example.

In another example, the coupling comprises a flexible shaft.

In another example, the valve shaft and actuator shaft are offset from each other and the coupling comprises a linkage.

In each of these examples, the thermal isolator serves to reduce the heat transmission along a shaft from a valve to an actuator. Further, use of the thermal isolator allows more compact and flexible design configurations to be used.

These and other features of the present invention can be best understood from the following specification and drawings, the following of which is a brief description.

### BRIEF DESCRIPTION OF THE DRAWINGS

FIG. 1 is a schematic view of one example of an exhaust valve assembly incorporating the subject invention.

FIG. 2 is a schematic view of another example of an exhaust valve assembly incorporating the subject invention.

FIG. 3 is a schematic view of another example of an exhaust valve assembly incorporating the subject invention.

FIG. 4 is a schematic view of another example of an exhaust valve assembly incorporating the subject invention.

### DETAILED DESCRIPTION OF THE PREFERRED EMBODIMENT

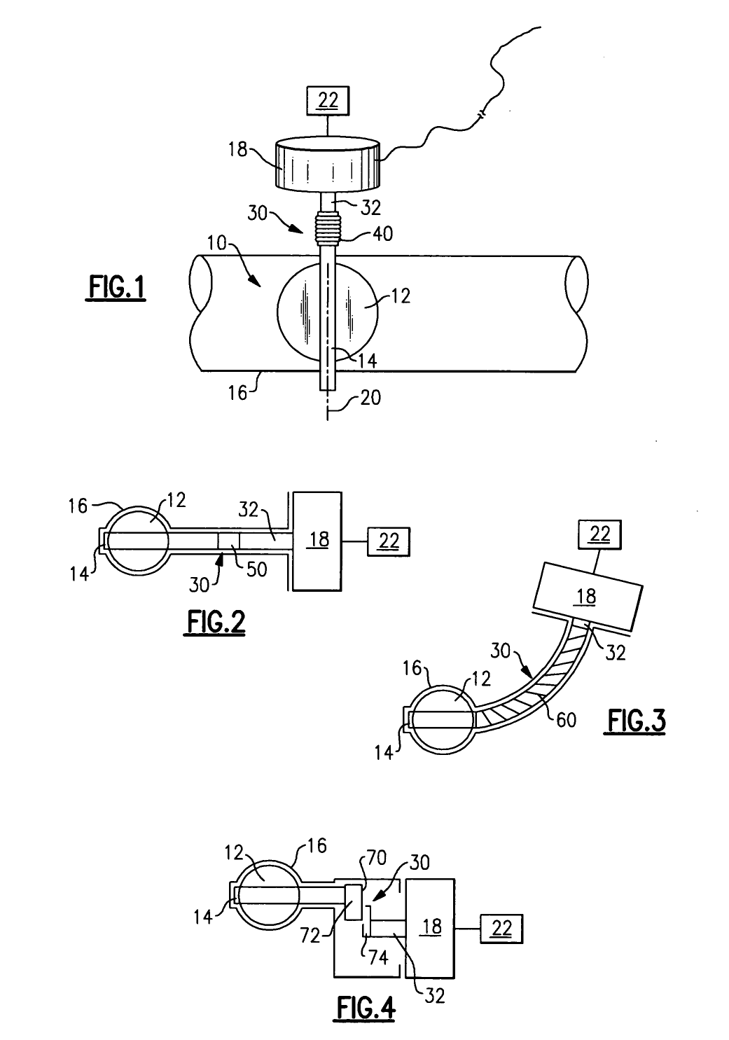

An exhaust valve assembly is shown generally at 10 in FIG. 1. The exhaust valve assembly 10 includes a valve 12 that is supported on a shaft 14. In the example shown, the valve 12 comprises a flapper valve that is mounted within a valve body 16, which comprises a tube. The valve body 16 is part of an exhaust system component and exhaust gases flow through the valve body 16.

An actuator 18 drives the shaft 14 to rotate about an axis 20. The valve 12 is fixed to the shaft 14 such that the shaft 14 and valve 12 pivot about the axis 20 together. The actuator 18 can be any type of actuator including a spring actuator, an electric actuator such as a motor or solenoid, or a vacuum actuator, for example. In the example shown, the actuator 18 comprises an electric actuator. A controller 22 cooperates with the actuator 18 to control exhaust flow through the valve body 16 by varying the position of the valve 12 as known.

During operation, the exhaust gases in the valve body 16 can reach very high temperatures. Thus, the valve 12 is exposed to high heat levels. Heat is transferred along the shaft 14 from the valve 12 to the actuator 18. If the heat transfer level is too high, performance of the actuator 18 can be adversely affected. In order to reduce the amount of heat transferred to the actuator 18, a thermal isolator 30 is associated with the shaft 14. The thermal isolator 30 serves to isolate the actuator 18 from the valve 12 in order to reduce an amount of heat transfer from the valve 12 to the actuator 18.

The thermal isolator 30 can be provided in many different configurations. In each configuration, the thermal isolator 30 comprises a coupling that couples an actuator shaft 32 to the shaft 14 that supports the valve 12. The actuator shaft 32 comprises a driving output from the actuator 18 and the coupling cooperates with the actuator shaft 32 and shaft 14 to transfer torque between the actuator 18 and the valve 12.

As shown in FIG. 1, one thermal isolator 30 comprises a bellows 40. In the example shown, the bellows 40 comprises a flexible metal bellows, however, other types of material could also be used. The bellows 40 serves to couple the actuator shaft 32 to the shaft 14 for the valve 12, and thus thermally isolates the shafts 32, 14 from direct contact with each other. This significantly reduces the amount of heat transfer from the valve 12 to the actuator 18.

Further, because the bellows 40 comprises a flexible connecting member, the bellows 40 can accommodate any mis-alignment between the shaft 14 and the actuator shaft 32, and can compensate for any shaft thermal expansion that may occur. Additionally, use of the bellows 40 allows shorter shaft lengths to be used, which provides for a more compact design.

In the example shown in FIG. 2, the thermal isolator 30 comprises a direct coupling 50 between the shaft 14 and the actuator shaft 32. The direct coupling 50 comprises a non-metallic heat insulating material that is coupled directly between the shaft 14 and actuator shaft 32. The non-metallic heat insulating material could be a ceramic or silicon material, however other materials could also be used.

The direct coupling 50 comprises a rigid connecting element that is threaded or otherwise attached to both shafts 14, 32. In this configuration, the direct coupling 50, the shaft 14 for the valve 12, and the actuator shaft 32 are co-axial with each other, and with axis 20. Because the direct coupling 50 is made from a heat insulating material, the shafts 14, 32 are thermally isolated from each other, which significantly reduces heat transfer to the actuator 18. Further, use of the direct coupling 50 allows shorter shaft lengths to be used, which provides for a more compact design.

In the example shown in FIG. 3, the thermal isolator 30 comprises a flexible shaft 60 that extends between the valve 12 and the actuator 18. The flexible shaft 60 can be coupled to the shaft 14 and to the actuator shaft 32 with any type of connecting interface. In the example shown, the shafts 14, 32 are significantly shorter than in the other example configurations. However, the flexible shaft 60 could directly connect the valve 12 to the actuator 18 without requiring additional lengths for shafts 14, 32.

The flexible shaft 60 can be made from any type of material including metallic and non-metallic materials. A heat insulating material is preferred to reduce the amount of heat transfer from the valve 12 to the actuator 18, however, if a metallic material is used, the length of the flexible shaft 60 can be optionally increased to reduce the effects of heat transfer. Due to the flexibility of the flexible shaft, increasing the length of the shaft does not necessarily adversely affect packaging.

In the example shown in FIG. 4, the shaft 14 is offset from the actuator shaft 32. The actuator shaft 32 is generally parallel to, but not co-axial with, the axis 20. The thermal isolator 30 comprises a linkage 70 that couples the shaft 14 to the actuator shaft 32. The linkage 70 includes at least a first link member 72 coupled to the shaft 14 and a second link member 74 coupled to the actuator shaft 32. The first 72 and second 74 link members cooperate with each other to transfer torque between the actuator 18 and valve 12. By offsetting the shafts 14, 32 in combination with a connecting linkage 70, heat transfer from the valve 12 to the actuator 18 is significantly reduced.

In each of the configurations set forth above, the thermal isolator 30 serves to reduce the heat transmission from a valve subjected to high exhaust gas temperatures to an actuator. Additionally, the use of the thermal isolator 30 as described above provides for more compact and flexible design configurations.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An exhaust valve assembly comprising:
a valve body;
a valve supported for movement within said valve body;
an actuator that varies a position of said valve within said valve body to control exhaust flow; and
a thermal isolator associated with said valve to reduce heat transfer from said valve to said actuator.

2. The exhaust valve assembly according to claim 1 including a shaft that supports said valve with said actuator driving said shaft to control the position of the valve within the valve body.

3. The exhaust valve assembly according to claim 2 wherein said shaft comprises a valve shaft, and including an actuator shaft driven by said actuator wherein said thermal isolator comprises a coupling that couples said actuator shaft to said valve shaft to transfer torque between said actuator and said valve.

4. The exhaust valve assembly according to claim 3 wherein said coupling comprises a bellows.

5. The exhaust valve assembly according to claim 4 wherein said bellows comprises a flexible metal bellows.

6. The exhaust valve assembly according to claim 3 wherein said coupling comprises a rigid connector made from an insulating material.

7. The exhaust valve assembly according to claim 6 wherein said insulating material comprises one of ceramic and silicon.

8. The exhaust valve assembly according to claim 6 wherein said valve shaft is made from a metallic material.

9. The exhaust valve assembly according to claim 6 wherein said rigid connector, said valve shaft, and said actuator shaft are co-axial.

10. The exhaust valve assembly according to claim 3 wherein said valve shaft is offset from said actuator shaft and wherein said coupling comprises a linkage.

11. The exhaust valve assembly according to claim 10 wherein said linkage includes at least a first link member coupled to said valve shaft and a second link member coupled to said actuator shaft with said first and second link member cooperating with each other to transfer torque between said actuator and said valve.

12. The exhaust valve assembly according to claim 3 wherein said coupling comprises a flexible shaft.

13. The exhaust valve assembly according to claim 2 wherein said actuator comprises an electric actuator.

14. The exhaust valve assembly according to claim 2 wherein said valve comprises a flapper valve and said valve body comprises an exhaust tube.
